(19) United States
(12) Patent Application Publication
(10) Pub. No.: US 2024/0367203 A1
(43) Pub. Date: Nov. 7, 2024

(54) Process for Keeping a Surface Clear which is Susceptible to Inorganic or Organic Deposits

(71) Applicant: HASYTEC D&P GMBH, Kiel (DE)

(72) Inventors: Andreas HOFFMANN, Barmstedt (DE); Jan Peter KELLING, Preetz (DE)

(21) Appl. No.: 18/683,424

(22) PCT Filed: Jul. 18, 2022
(86) PCT No.: PCT/DE2022/100515

§ 371 Date: Feb. 13, 2024

(30) Foreign Application Priority Data
Aug. 20, 2021 (DE) 10 2021 121 611.7

(51) Int. Cl. B08B 7/02; B08B 3/12; B08B 9/027; B08B 9/08

(52) U.S. Cl. CPC B08B 7/028; B08B 3/12; B08B 9/027; B08B 9/08

(57) ABSTRACT

Ultrasonic generators fastened to a body are used as ultrasonic probes which, on account of the inverse piezoelectric effect, are thus used for emitting ultrasound and, on account of the piezoelectric effect, are also used for detecting (ultra)sound. In the process, a plurality of ultrasonic probes are initially fastened at predetermined positions on a surface, which positions likely ensure the largest possible surface area coverage, wherein this is thereby checked regarding whether a sound event emitted by a single ultrasonic probe can be detected by at least one other ultrasonic probe. Since in each case only one ultrasonic probe is connected for emitting a sound event and the remaining ultrasonic probes are connected for receiving, in each case the position of each ultrasonic probe can be adjusted, which leads to optimised surface area coverage. Optionally, the number of provided ultrasonic probes can also be increased or reduced.

The invention relates to a method for keeping a surface of a body susceptible to deposits clear and/or for removing deposits adhering to a surface of a body by means of ultrasound.

The use of ultrasound to remove inorganic or organic deposits adhering to surfaces, e.g. adhering biofilm, or to prevent their formation, for example on the outer shell of watercraft or on the inside of containers or pipes, is known, for example, from DE 10 2019 203 069 A1. A piezo ultrasonic transducer is bonded to the opposite side of the surface to be kept free or cleaned in order to remove or keep free such deposits on liquid-carrying surfaces or surfaces in contact with liquids by means of ultrasound. A control unit equipped with an ultrasonic generator excites the ultrasonic transducer with a suitable frequency and power, the combination of which is usually below the cavitation limit in order to prevent damage caused by cavitation effects. Due to the rather limited power and the associated short range of a single ultrasonic transducer, several ultrasonic transducers must therefore be used for larger areas.

However, it is impossible to determine 100% area coverage in advance due to reinforcements, attachments, corners, edges or angles of the bodies comprising the surface to be treated, including different filling levels, flow velocities or pressure forces of the medium, each of which have an influence on the range of the emitted ultrasound.

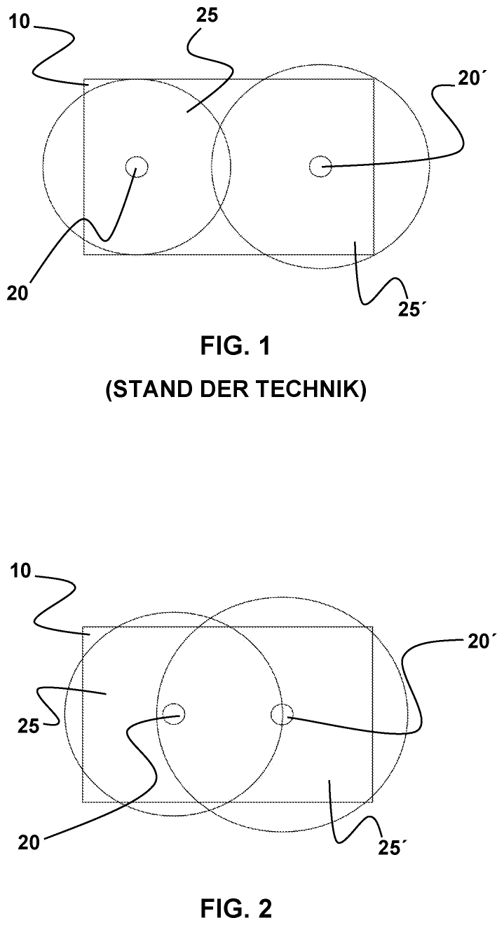

This problem is illustrated in FIG. 1, which shows the surface of a body 10 that is to be sonicated as fully as possible using the two ultrasonic transducers 20, 20′. However, it can be seen that the ranges 25, 25′ of the ultrasonic transducers 20, 20′ differ at their predetermined positions due to the structural or material properties of the body 10, so that only patchy surface coverage is achieved, so that the surface of the body is still susceptible to deposits, especially biogenic growth with (micro) organisms that form a biofilm.

Therefore, it is an object of the invention to create a method for keeping a surface of a body clear of deposits, in particular biogenic growth, and/or for removing deposits adhering to a surface of a body, in particular adhering biofilm, by means of ultrasound, with the aid of which an area coverage of as much as 100% as possible can be achieved.

According to the invention, this object is solved by the method with the features of claim 1. The dependent claims describe advantageous embodiments of the invention.

The basic idea of the invention is to use the ultrasonic transducers attached to a body as ultrasonic probes, which are thus set up to emit ultrasound due to the inverse piezoelectric effect as well as to detect (ultra)sound due to the piezoelectric effect. A plurality of ultrasonic probes are initially attached to predetermined positions on a surface which are likely to ensure the greatest possible area coverage, this being checked in accordance with the invention by determining whether a sound event emitted by a single ultrasonic probe can be detected by at least one other ultrasonic probe. By switching only one ultrasonic probe at a time to output a sound event and the other ultrasonic probes to receive and preferably checking the position of each ultrasonic probe, the position of each ultrasonic probe can be adjusted, resulting in optimised area coverage. If need be, the number of ultrasonic probes provided can also be increased or reduced so that an optimised method for keeping a surface of a body that is susceptible to deposits free and/or for removing deposits adhering to a surface of a body by means of ultrasound can be provided.

According to the invention, a method is thus proposed for keeping a surface of a body susceptible to deposits free and/or for removing deposits adhering to a surface of a body by means of ultrasound, comprising the following steps:
a. Attaching a predetermined plurality of ultrasonic probes to predetermined positions of a body having at least one surface susceptible to or having deposits;
b. Subjecting the body to ultrasound by means of a single ultrasonic probe selected from the predetermined plurality of ultrasonic probes;
c. Detecting the ultrasound emitted by the one ultrasonic probe by the remaining ultrasonic probes of the plurality of ultrasonic probes as an ultrasonic event;
d. if need be, Repeating steps b. and c., wherein the body is exposed to ultrasound by means of a further ultrasonic probe determined as a selected ultrasonic probe until each ultrasonic probe of the plurality of ultrasonic probes has exposed the body to ultrasound;
e. Repositioning at least the selected ultrasonic probe in the absence of an ultrasonic event expected for at least one of the remaining ultrasonic probes or in the event of detection of an ultrasonic event by at least one of the remaining ultrasonic probes with a lower sound energy than a predetermined sound energy;
f. Repeating steps b. to e. until the at least one of the remaining ultrasonic probes detects an ultrasonic event with at least the predetermined sound energy; and
g. Exposing the body to ultrasound by means of all ultrasonic probes attached to the body.

The deposits to be prevented or removed may be inorganic and/or organic deposits, which specifically may be of biogenic origin. It is particularly preferable for the bodies to be treated to have surfaces that are susceptible to biogenic growth or to which biofilm adheres. Accordingly, the deposits for which the method is used are preferably inorganic and/or organic deposits and/or deposits forming a biofilm.

Preferably, the repositioning process comprises reattaching the selected ultrasound probe to the same predetermined position. In the event that an ultrasound event expected for at least one of the remaining ultrasound probes does not occur, it is possible that the selected ultrasound probe has not been properly attached to the predetermined position of the body. The correct attachment of the selected ultrasound probe must therefore be checked and reattached if necessary.

Alternatively or, if necessary, additionally, repositioning also includes reattaching the ultrasound probe for which the expected ultrasound event did not occur. It is also possible that not the selected ultrasound probe, but one of the remaining ultrasound probes of the multiple ultrasound probes that are to record the ultrasound event, is not properly attached to the body. It may therefore also be necessary to check that this ultrasound probe is properly attached and preferably reattached.

In any case, repositioning also includes replacing a defective ultrasound probe with an intact ultrasound probe, especially if repositioning the selected or the remaining ultrasound probe does not produce any other effect. In this case, the selected and/or the remaining ultrasound probe is considered defective and is replaced with an intact ultrasound probe.

It is preferably provided that not each of the remaining ultrasonic probes must detect a sound event generated by the selected ultrasonic probe, but preferably at least one of the remaining ultrasonic probes which is arranged directly adjacent to the selected ultrasonic probe. For this purpose, a predetermined radius or distance can be defined from one of the remaining ultrasonic probes to the selected ultrasonic probe, which must detect a sound event with a lower sound energy than a predetermined sound energy in order to trigger repositioning. For example, it may be specifically provided that a defined plurality of remaining ultrasonic probes, which are arranged adjacent to the selected ultrasonic probe within a predetermined radius, must detect a sound event with a lower sound energy than a predetermined sound energy in order to initiate repositioning.

It is further preferably provided that the body is a wall or a walling, the ultrasonic probes being located on the side or surface of the wall or walling opposite that surface of the same wall or walling which is susceptible to deposits or has deposits. In particular, the ultrasonic probes are located on that surface of the wall or walling which is largely protected from moisture and does not come into contact with it, the surface to be treated being the surface which comes into direct contact with moisture.

Specifically, the body is a ship's hull, with the plurality of ultrasonic probes being attached to the inside of the hull to keep the outer surface of the hull clear of deposits and/or to remove deposits adhering to the outer surface of the hull. In this case, the ultrasonic probes are therefore located on the inside of the (ship's) hull.

However, the body can also preferably be a liquid-receptive container or a liquid-conducting pipe. Most preferably, the body is a cooling tower, a tank of a sewage treatment plant or the tank of a biogas plant. In this case, the ultrasound probes are located on the outside of the respective body. The process according to the invention is therefore particularly suitable in the field of shipping, especially for treating cooling systems of all kinds (sea chests, filter housings, pipes, plate heat exchangers, box/box coolers), propellers of all kinds, fresh water generators and ship hulls. In the industrial sector, the process according to the invention is suitable for treating evaporative cooling systems, plate heat exchangers carrying cooling/process media, especially thick juice coolers, raw juice heaters, juice purifiers, milk heaters, machines, pipes and tanks carrying cooling/process media, wet separators, bottle washing machines, pasteurisers and paper production machines, especially glue distributors and colour coating machines.

The invention is explained in more detail with reference to a particularly preferred embodiment example shown in the attached FIG. 2. FIG. 2 shows the identical body 10 known from FIG. 1 with a modified arrangement of the ultrasonic probes 20, 20′ as a result of the method according to the invention.

By means of the selected ultrasonic probe 20 arranged on the left in the example, the body 10 was exposed to ultrasound, which—as FIG. 1 shows—could not be detected by the ultrasonic probe 20′ arranged on the right, or not with the predetermined sound energy. The reverse function check by sound emission by the right ultrasonic probe 20′ and insufficient detection of a sound event by the left ultrasonic probe 20 also resulted in no detection or detection with insufficient sound energy. By iteratively adjusting the positions, the state shown in FIG. 2 was finally achieved. On the one hand, it can be seen that the ultrasonic probes 20, 20′ have changed positions compared to FIG. 1. On the other hand, it can be seen that the ranges 25, 25′ of the ultrasonic probes 20, 20′ have changed due to the changed positions. Overall, this leads to improved area coverage with ultrasound compared to FIG. 1 and thus to improved prevention of deposits, for example biofilm on the surface of the body 10. With the positioning of the ultrasonic probes 20, 20′ found in this way, ultrasound can be applied over a large area to effectively prevent or remove deposits, in particular biofilm growth.

1. A method for keeping a surface of a body susceptible to deposits clear and/or for removing deposits adhering to the surface of the body by ultrasound, comprising the steps of:
a. Attaching a predetermined plurality of ultrasonic probes to predetermined positions of the body having at least one surface susceptible to or having deposits;
b. Subjecting the body to ultrasound by a single ultrasonic probe selected from the predetermined plurality of ultrasonic probes;
c. Detecting the ultrasound emitted by the one ultrasonic probe by the remaining ultrasonic probes of the plurality of ultrasonic probes as an ultrasonic event;
d. if need be, Repeating steps b. and c., wherein the body is exposed to ultrasound by a further ultrasonic probe determined as a selected ultrasonic probe until each ultrasonic probe of the plurality of ultrasonic probes has exposed the body to ultrasound;
e. Repositioning at least the selected ultrasonic probe in the absence of an ultrasonic event expected for at least one of the remaining ultrasonic probes or in the event of detection of an ultrasonic event by at least one of the remaining ultrasonic probes with a lower sound energy than a predetermined sound energy;
f. Repeating steps b. to e. until the at least one of the remaining ultrasonic probes detects an ultrasonic event with at least the predetermined sound energy; and
g. Exposing the body to ultrasound by all ultrasonic probes attached to the body.

2. The method according to claim 1, wherein the deposits are inorganic deposits and/or organic deposits and/or deposits forming a biofilm.

3. The method according to claim 1, wherein the repositioning comprises reattaching the selected ultrasonic probe to the same predetermined position.

4. The method according to claim 1, wherein the repositioning comprises reattaching the ultrasound probe for which the expected ultrasound event has failed to occur.

5. The method according to claim 1, wherein the repositioning comprises replacing a defective ultrasonic probe with an intact ultrasonic probe.

6. The method according to claim 1, wherein the at least one of the remaining ultrasonic probes, which detects a sound event with a lower sound energy than a predetermined sound energy, is arranged directly adjacent to the selected ultrasonic probe.

7. The method according to claim 1, wherein the body is a ship's hull, wherein the plurality of ultrasonic probes are fixed to the inside of the ship's hull for keeping the outer surface of the ship's hull, which is susceptible to deposits, clear of deposits and/or for removing deposits adhering to the outer surface of the ship's hull.

8. The method according to claim 1, wherein the body is a liquid-receiving container or a liquid-conducting pipe.

9. The method according to claim 8, wherein the body is a cooling tower, a tank of a sewage treatment plant or the tank of a biogas plant.

10. The method according to claim 2, wherein the repositioning comprises reattaching the selected ultrasonic probe to the same predetermined position.

11. The method according to claim 2, wherein the repositioning comprises reattaching the ultrasound probe for which the expected ultrasound event has failed to occur.

12. The method according to claim 2, wherein the repositioning comprises replacing a defective ultrasonic probe with an intact ultrasonic probe.

13. The method according to claim 2, wherein the at least one of the remaining ultrasonic probes, which detects a sound event with a lower sound energy than a predetermined sound energy, is arranged directly adjacent to the selected ultrasonic probe.

14. The method according to claim 2, wherein the body is a ship's hull, wherein the plurality of ultrasonic probes is fixed to the inside of the ship's hull for keeping the outer surface of the ship's hull, which is susceptible to deposits, clear of deposits and/or for removing deposits adhering to the outer surface of the ship's hull.

15. The method according to claim 2, wherein the body is a liquid-receiving container or a liquid-conducting pipe.

16. The method according to claim 15, wherein the body is a cooling tower, a tank of a sewage treatment plant or the tank of a biogas plant.

17. The method according to claim 3, wherein the repositioning comprises reattaching the ultrasound probe for which the expected ultrasound event has failed to occur.

18. The method according to claim 4, wherein the repositioning comprises replacing a defective ultrasonic probe with an intact ultrasonic probe.

19. The method according to claim 5, wherein the at least one of the remaining ultrasonic probes, which detects a sound event with a lower sound energy than a predetermined sound energy, is arranged directly adjacent to the selected ultrasonic probe.

20. The method according to claim 6, wherein the body is a ship's hull, wherein the plurality of ultrasonic probes is fixed to the inside of the ship's hull for keeping the outer surface of the ship's hull, which is susceptible to deposits, clear of deposits and/or for removing deposits adhering to the outer surface of the ship's hull.
